(19) United States
(12) Patent Application Publication
(10) Pub. No.: US 2025/0337348 A1
(43) Pub. Date: Oct. 30, 2025

(54) ELECTRIC CIRCUIT

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Hironori AKIYAMA, Nisshin-shi (JP); Masato TAKI, Nisshin-shi (JP)

(21) Appl. No.: 19/046,914

(22) Filed: Feb. 6, 2025

(30) Foreign Application Priority Data
Apr. 30, 2024 (JP) 2024-073516
Oct. 24, 2024 (JP) 2024-187689

(51) Int. Cl. H02P 27/08

(52) U.S. Cl. CPC H02P 27/08

(57) ABSTRACT

An electric circuit includes a battery, a motor, an inverter, and a controller. The inverter is connected between the battery and the motor. The inverter includes a smoothing capacitor and series switch circuits. The smoothing capacitor is connected between a high-potential input wiring and a low-potential input wiring. The series switch circuits are connected between the high-potential input wiring and the low-potential wiring. In a case where the controller receives a warming command during a stop of a vehicle. The controller executes a warming operation by: controlling one of an upper switching element and a lower switching element in at least one of the series switch circuits to a regular on-state; and controlling another one of the upper switching element and the lower switching element in the at least one of the series switch circuits to a high-dissipation on-state. The high-dissipation on-state results in higher dissipation than the regular on-state.

### CROSS REFERENCE TO RELATED APPLICATIONS

This application claims the benefits of priority from Japanese Patent Application No. 2024-073516 filed on Apr. 30, 2024 and Japanese Patent Application No. 2024-187689 filed on Oct. 24, 2024. The entire disclosure of the above applications is incorporated herein by reference.

### TECHNICAL FIELD

The present disclosure relates to an electric circuit adapted to a vehicle.

### BACKGROUND

A vehicle may run on battery power. The vehicle may have a motor and an inverter. The inverter may drive the motor by converting DC power supplied by the battery into AC power and supplying it to the motor.

### SUMMARY

The present disclosure describes an electric circuit that is adapted to a vehicle, and further describes that the electric circuit includes a battery, a motor, an inverter and a controller.

### BRIEF DESCRIPTION OF DRAWINGS

FIG. 1 illustrates a circuit diagram of an electric circuit.

FIG. 2 illustrates a cooling system for cooling down a battery and an inverter.

FIG. 3 shows a graph that illustrates a control signal to switching elements during a warming operation in a first embodiment.

FIG. 4 shows a graph that illustrates a gate potential at each switching element during the warming operation in the first embodiment.

FIG. 5 shows a graph that indicates a change in the gate potential during switchover between a first operation and a second operation in the first embodiment.

FIG. 6 shows a graph that indicates a change in a gate potential during switchover between a first operation and a second operation in a modified example of the first embodiment.

FIG. 7 illustrates a circuit diagram of an electric circuit in the modified example.

FIG. 8 illustrates a graph that indicates a gate potential at each switching element during a warming operation in a second embodiment.

FIG. 9 illustrates a graph that indicates a change in the gate potential during switchover between a first operation and a second operation in the second embodiment.

FIG. 10 illustrates a circuit diagram of a gate drive circuit in a third embodiment.

FIG. 11 shows a graph that indicates a gate potential at each switching element during a warming operation in a third embodiment.

FIG. 12 illustrates a circuit diagram of a gate drive circuit in a fourth embodiment.

FIG. 13 illustrates a graph that indicates a gate potential at each switching element during a warming operation in a fifth embodiment.

FIG. 14 illustrates a circuit diagram of a gate drive circuit in a fifth embodiment.

FIG. 15 illustrates a graph that indicates a gate potential at a switching element during an operation of rotating a motor in the fifth embodiment.

FIG. 16 illustrates a graph that indicates a gate potential and a voltage between a drain and a source in a switching element during a high-dissipation on-state in the fifth embodiment.

### DETAILED DESCRIPTION

In a vehicle related to a comparative example, when the temperature of the battery decreases, the charging and discharging performance of the battery may degrade. The vehicle may supply a d-axis current to the motor as a battery warming operation, when the vehicle is stopped and the battery temperature is low. The d-axis current may allow the battery to be discharged without rotating the motor. The self-heating caused by battery discharge may increase the temperature of the battery.

In the vehicle related to the comparative example, the q-axis current is controlled to zero when the d-axis current is supplied. However, due to errors, a small q-axis current may be generated, resulting in a small torque being produced by the motor. As a result, noise is generated during a warming operation.

According to an aspect of the present disclosure, an electric circuit is adapted to a vehicle. The electric circuit includes: a battery; a motor; an inverter connected between the battery and the motor; and a controller. The inverter includes: a high-potential input wiring; a low-potential input wiring; output wirings connected to the motor; a smoothing capacitor connected between the high-potential input wiring and the low-potential input wiring; and series switch circuits connected between the high-potential input wiring and the low-potential input wiring. Each of the series switch circuits includes: an upper switching element connected between the high-potential input wiring and a corresponding one of the output wirings; and a lower switching element connected between the low-potential input wiring and a corresponding one of the output wirings. The controller executes a warming operation in at least one of the series switch circuits in a case where the controller receives a warming command during a stop of the vehicle. The warming operation is an operation in which the controller sets one of the upper switching element and the lower switching element to a regular on-state, and sets another one of the upper switching element and the lower switching element to a high-dissipation on-state. The high-dissipation on-state has higher energy dissipation than the regular on-state.

In this electric circuit, when battery warming is necessary, the controller controls one of the upper switching element and the lower switching element to regular on-state and controls the other to high-dissipation on-state in at least one series switch circuit. Since the high potential line and the low potential line are connected by the switching element controlled to regular on-state and the switching element controlled to high-dissipation on-state, the smoothing capacitor is discharged through these switching elements. At this time, high dissipation occurs in the switching element controlled to high-dissipation on-state, causing this switching element to generate heat. The heat generated by the switching elements can raise the battery temperature. Furthermore, since the discharge path in this case does not pass through the motor, the generation of torque in the motor can be suppressed. Therefore, battery warming can be performed while suppressing the generation of noise in the motor.

### First Embodiment

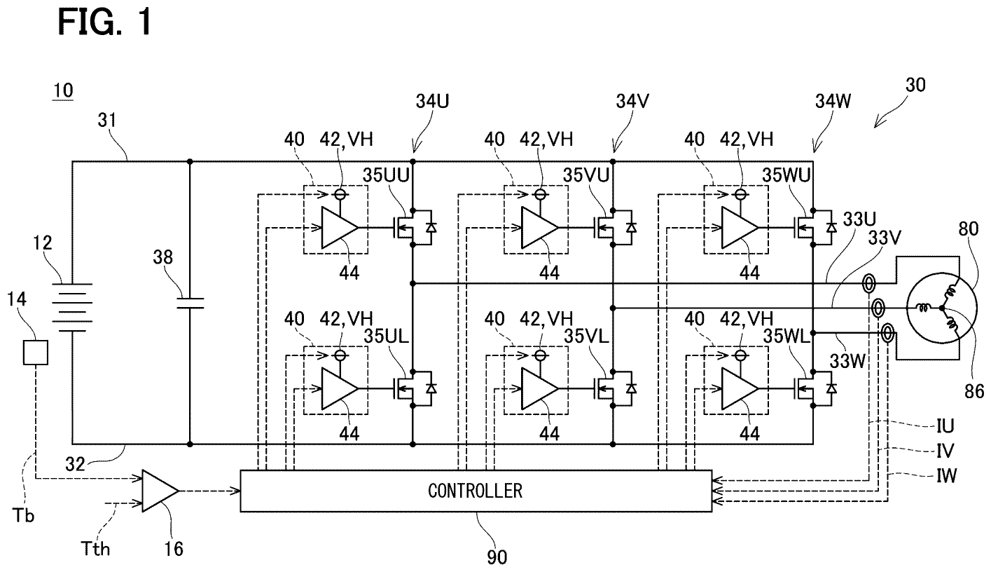

An electric circuit 10 shown in FIG. 1 is adapted to a vehicle. The electric circuit 10 includes a battery 12, an inverter 30, a motor 80, and a controller 90. The battery 12 is a main battery of the vehicle and outputs direct current (DC) power. The motor 80 is a three-phase motor that rotates the drive wheels of the vehicle. The inverter 30 converts the DC power supplied from the battery 12 into alternating current (AC) power and supplies it to the motor 80. As a result, the motor 80 rotates the drive wheels, causing the vehicle to move. The controller 90 controls each part of the electric circuit 10. The controller 90 may include a single circuit board or multiple circuit boards that are physically separated.

A battery temperature sensor 14 is adapted to the battery 12. The battery temperature sensor 14 detects the temperature Tb of the battery 12. The value of the temperature Tb detected by the battery 12 is provided to a comparator 16. The comparator 16 sends a warming command to the controller 90 when the temperature Tb is lower than the threshold Tth. The warming command may also be referred to as a warm-up command in the present disclosure.

The motor 80 has three windings. One end of each winding is connected to each other at a neutral point 86. The other end of each winding is connected to the corresponding input terminal of the motor 80.

The inverter 30 has a high-potential input wiring 31, a low-potential input wiring 32, and three output wirings 33U, 33V, and 33W. The high-potential input wiring 31 is connected to a positive electrode of the battery 12. The low-potential input wiring 32 is connected to the negative electrode of the battery 12. In FIG. 1, the high-potential input wiring 31 and the low-potential input wiring 32 are directly connected to the battery 12. However, the high-potential input wiring 31 and the low-potential input wiring 32 may also be connected to the battery 12 through other circuits, such as a DC-DC converter. A smoothing capacitor 38 is connected between the high-potential input wiring 31 and the low-potential input wiring 32. Each of the output wirings 33U, 33V, and 33W is connected to the corresponding input terminal of the motor 80. The output wirings 33U, 33V, and 33W are connected to the neutral point 86 via the internal windings of the motor 80. Current sensors are provided for the respective output wirings 33U, 33V, and 33W. The current sensors detect the currents IU, IV, and IW flowing through the output wirings 33U, 33V, and 33W, respectively. The values of the currents IU, IV, and IW detected by the respective current sensors are provided to the controller 90.

The inverter 30 has three series switch circuits 34U, 34V, and 34W connected between the high-potential input wiring 31 and the low-potential input wiring 32. Each of the series switch circuits 34U, 34V, and 34W has two switching elements 35 connected in series between the high-potential input wiring 31 and the low-potential input wiring 32. The switching element 35 is a gate-type transistor. In FIG. 1, each switching element 35 is shown as a MOSFET (metal-oxide-semiconductor field effect transistor), but each switching element 35 may also be an IGBT (insulated gate bipolar transistor) or the like. In the following, with regard to the two switching elements 35 connected in series, the one connected to the high-potential input wiring 31 is referred to as the upper switching element, and the one connected to the low-potential input wiring 32 is referred to as the lower switching element. In the series switch circuit 34U, the upper switching element 35UU is connected between the high-potential input wiring 31 and the output wiring 33U, and the lower switching element 35UL is connected between the output wiring 33U and the low-potential input wiring 32. In the series switch circuit 34V, the upper switching element 35VU is connected between the high-potential input wiring 31 and the output wiring 33V, and the lower switching element 35VL is connected between the output wiring 33V and the low-potential input wiring 32. In the series switch circuit 34W, the upper switching element 35WU is connected between the high-potential input wiring 31 and the output wiring 33W, and the lower switching element 35WL is connected between the output wiring 33W and the low-potential input wiring 32. Each switching element 35 has a freewheeling diode connected in parallel. Each freewheeling diode has its cathode connected to the high-potential terminal (i.e., the drain) of the corresponding switching element 35, and its anode connected to the low-potential terminal (i.e., the source) of the corresponding switching element 35.

The inverter 30 has six gate drive circuits 40. Each gate drive circuit 40 is connected to the gate of a corresponding one of the switching element 35 as a controlled target. Each gate drive circuit 40 varies the potential at the gate of the switching element 35 between the gate-on potential VH and the gate-off potential VL according to the command values input from the controller 90. The gate-on potential VH is higher than the gate threshold of the switching element 35. The gate-off potential VL is lower than the gate threshold of the switching element 35. Each gate drive circuit 40 controls the gate potential at the corresponding switching element 35 with reference to the potential at the low-potential terminal (i.e., the source) of that switching element 35. In other words, the potentials VH and VL are indicated with respect to the potential at the source of the switching element 35. Therefore, for the upper switching elements 35UU, 35VU, and 35WU, the potentials VH and VL are indicated with respect to the output wiring 33U, 33V, and 33W. For example, for the upper switching elements 35UU, 35VU, and 35WU, the potential VL may be at the same potential as the output wiring 33U, 33V, and 33W, or the potential VH may be higher than the output wiring 33U, 33V, and 33W. For the lower switching elements 35UL, 35VL, and 35WL, the potentials VH and VL are indicated with respect to the low-potential input wiring 32. For example, for the lower switching elements 35UL, 35VL, and 35WL, the potential VL may be at the same potential as the low-potential input wiring 32, and the potential VH may be higher than the low-potential input wiring 32. Each gate drive circuit 40 includes a power supply circuit 42 and a gate potential output circuit 44. The power supply circuit 42 outputs the gate-on potential VH. The power supply circuit 42 can vary the gate-on potential VH according to the command values input from the controller 90. The gate potential output circuit 44 varies the potential at the gate of the switching element 35 between the gate-on potential VH and the gate-off potential VL according to the command values input from the controller 90.

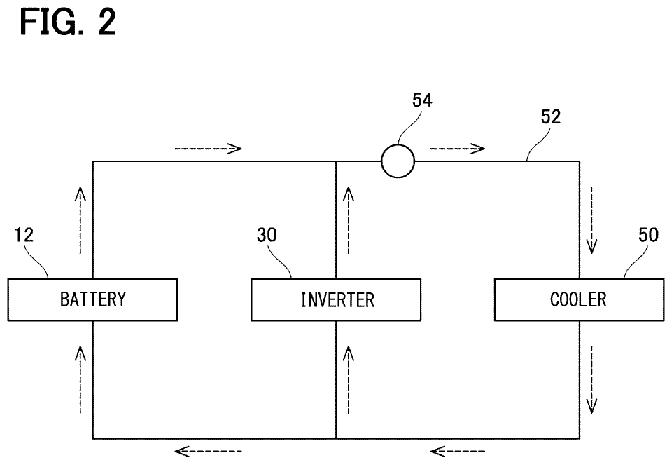

As shown in FIG. 2, the vehicle has a cooling mechanism that cools the inverter 30 and the battery 12. The cooling mechanism has a cooler 50, a coolant flow path 52, and a pump 54. Coolant flows in the coolant flow path 52. The coolant flow path 52 may also be referred to as a coolant channel in the present disclosure. The pump 54 circulates the coolant in the coolant flow path 52. The coolant may also be referred to as a cooling liquid in the present disclosure. The cooler 50 includes a radiator or heat exchanger, which cools the coolant in the coolant flow path 52 by heat exchange. The coolant flow path 52 is arranged to pass through both the inverter 30 and the battery 12. The coolant flow path 52 is arranged in a position where it can exchange heat with each switching element 35 of the inverter 30. During vehicle operation, the inverter 30 and each switching element 35 are cooled by the coolant flowing through the coolant flow path 52.

When the vehicle is running, the gate-on potential VH output by each power supply circuit 42 is fixed at the first gate-on potential VH1 (for example, 20V). The first gate-on potential VH1 is sufficiently higher than the gate threshold of the switching element 35. Each switching element 35 turns on normally when the first gate-on potential VH1 is applied to its gate. A regular on-state refers to the state in which the switching element 35 is in on-state with a low on-resistance. When the vehicle is running, the controller 90 switches each switching element 35 by alternating the gate potential between the gate-off potential VL and the first gate-on potential VH1. The controller 90 switches each switching element 35 to convert the DC power output by the battery 12 into three-phase AC power, which is then supplied to the motor 80. The controller 90 controls the torque and rotational speed of the motor 80 by regulating the amplitude and frequency of the three-phase AC current supplied to the motor 80. In this way, power is supplied to the motor 80, which drives the motor and enables the vehicle to run.

When the vehicle is stationary, the battery 12 may be cooled down by external air or other factors. When the temperature Tb of the battery 12 falls below the threshold Tth, the comparator 16 provides a warming command to the controller 90. The controller 90 executes the warming operation upon receiving the warming command. In the present disclosure, the warming operation may also be referred to as a warm-up operation.

During the warming operation, the controller 90 circulates the coolant within the coolant flow path 52 by operating the pump 54. During the warming operation, the controller 90 does not execute cooling of the coolant by the cooler 50.

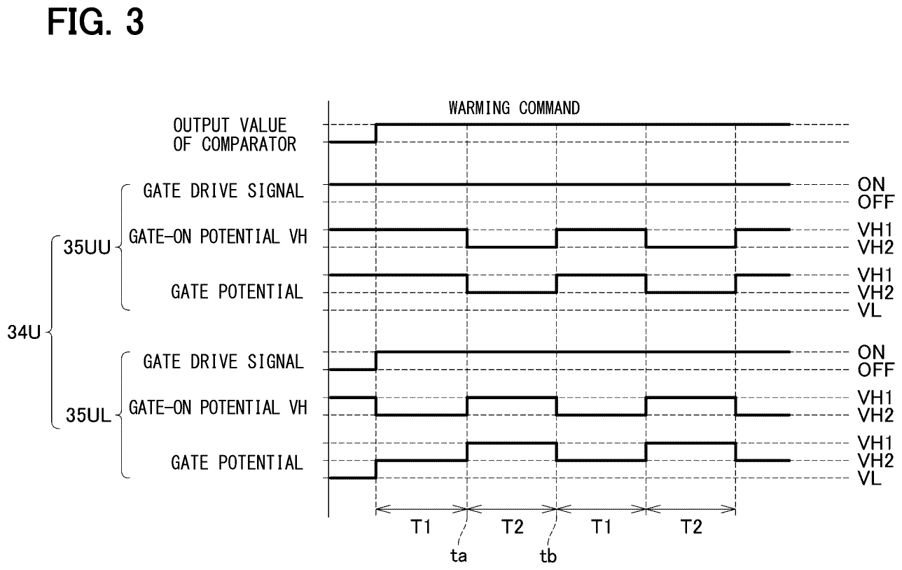

FIG. 3 shows the control signals to the switching elements 35UU and 35UL during the warming operation. FIG. 3 illustrates that the gate drive signal is the signal provided from the controller 90 to a gate potential output circuit 44. When the gate drive signal is at an ON level, the gate potential output circuit 44 applies the gate-on potential VH to the gate of the switching element 35. When the gate drive signal is at an OFF level, the gate potential output circuit 44 applies gate-off potential VL to the gate of switching element 35.

As shown in FIG. 3, when the warming operation starts, the controller 90 turns ON both the gate drive signal for the upper switching element 35UU and the gate drive signal for the lower switching element 35UL. Therefore, during the warming operation, the gate-on potential VH is applied to the gates of both the upper switching element 35UU and the lower switching element 35UL. The controller 90 controls each switching element 35 by managing the gate-on potential VH during the warming operation. The controller 90 alternately repeats the first operation and the second operation. In FIG. 3, period T1 is the duration during which the first operation is being executed, and period T2 is the duration during which the second operation is being executed.

In the first operation (i.e., during period T1), the controller 90 controls the gate-on potential VH for the upper switching element 35UU to a first gate-on potential VH1, and the gate-on potential VH for the lower switching element 35UL to a second gate-on potential VH2 (for example, 5V). The second gate-on potential VH2 is a potential that is higher than the gate threshold but lower than the first gate-on potential VH1. Therefore, in the first operation, the gate potential at the upper switching element 35UU becomes the first gate-on potential VH1, and the gate potential at the lower switching element 35UL becomes the second gate-on potential VH2. Since the first gate-on potential VH1 is sufficiently higher than the gate threshold of the switching element 35, the upper switching element 35UU, to which the first gate-on potential VH1 is applied, enters a regular on-state. On the other hand, because the difference between the second gate-on potential VH2 and the gate threshold is small, the lower switching element 35UL, to which the second gate-on potential VH2 is applied, turns on with a higher on-resistance than in the regular on-state. Therefore, the lower switching element 35UL experiences higher dissipation. Turning on in a state where higher dissipation occurs compared to the regular on-state is referred to as high-dissipation on-state. As described above, in the first operation, the upper switching element 35UU is in the regular on-state, while the lower switching element 35UL is in the high-dissipation on-state. Consequently, the smoothing capacitor 38 discharges through the upper switching element 35UU and the lower switching element 35UL, causing current to flow through the series switch circuit 34U. Since the upper switching element 35UU is in the regular on-state, it incurs minimal dissipation and generates very little heat. On the other hand, since the lower switching element 35UL is in the high-dissipation on-state, it incurs high dissipation and generates significant heat. Thus, in the first operation, the lower switching element 35UL generates heat.

In the second operation (i.e., period T2), the controller 90 adjusts the gate-on voltage VH for the upper switching element 35UU to the second gate-on voltage VH2, and the gate-on voltage VH for the lower switching element 35UL to the first gate-on voltage VH1. Therefore, in the second operation, the gate potential at the upper switching element 35UU becomes the second gate-on potential VH2, and the gate potential at the lower switching element 35UL becomes the first gate-on potential VH1. As a result, in the second operation, the upper switching element 35UU enters the high-dissipation on-state, and the lower switching element 35UL enters the regular on-state. Consequently, the smoothing capacitor 38 discharges through the upper switching element 35UU and the lower switching element 35UL, causing current to flow through the series switch circuit 34U. Since the lower switching element 35UL is in the regular on-state, it generates very little heat. On the other hand, since the upper switching element 35UU is in the high-dissipation on-state, it generates heat. Thus, in the second operation, the upper switching element 35UU generates heat.

Since the controller 90 alternates between the first operation and the second operation, the upper switching element 35UU and the lower switching element 35UL generate heat alternately during the warming operation.

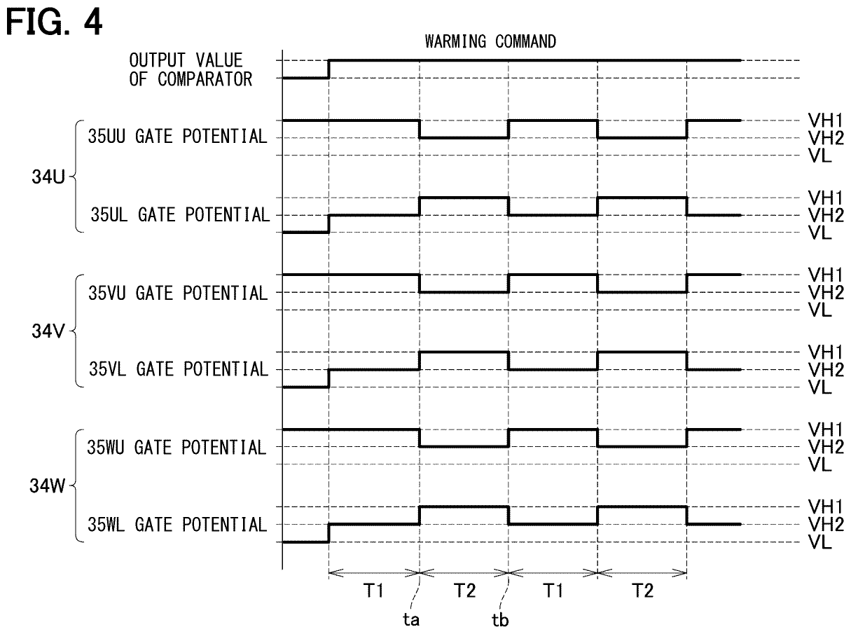

FIG. 4 shows the gate potentials of the six switching elements 35 during the warming operation. The gate potentials of the switching elements 35UU and 35UL in FIG. 4 are the same as those in FIG. 3. As shown in FIG. 4, during the warming operation, the controller 90 executes the first operation and the second operation in synchronization with the series switch circuit 34U for the series switch circuits 34V and 34W. Therefore, in the first operation (i.e., period T1), the upper switching elements 35UU, 35VU, and 35WU are in the regular on-state, and the lower switching elements 35UL, 35VL, and 35WL are in the high-dissipation on-state. Therefore, in the first operation, the lower switching elements 35UL, 35VL, and 35WL generate heat. Additionally, in the second operation (i.e., period T2), the lower switching elements 35UL, 35VL, and 35WL are in the regular on-state, and the upper switching elements 35UU, 35VU, and 35WU are in a high-dissipation on-state. Therefore, in the second operation, the upper switching elements 35UU, 35VU, and 35WU generate heat. In this way, during the warming operation, the upper switching elements 35UU, 35VU, and 35WU, and the lower switching elements 35UL, 35VL, and 35WL generate heat alternately.

Due to the heat generation of each switching element 35, the coolant circulating within the coolant flow path 52 is heated. By supplying the heated coolant to the battery 12, the temperature of the battery 12 increases. In this way, the warming operation can increase the temperature of the battery 12, allowing the recovery of the battery's charge and discharge performance.

As described above, during the warming operation, each switching element 35 is alternately switched between the regular on-state and the high-dissipation on-state. As a result, it prevents each switching element 35 from having a continuous heat generation period for a long time, thereby preventing the temperature of each switching element 35 from becoming excessively high. Additionally, since the upper switching elements and lower switching elements are alternately heated, the coolant can be heated efficiently. Additionally, since the warming operation is performed using the three series switch circuits 34, the coolant can be heated more efficiently. Thus, the temperature of the battery 12 can be raised efficiently.

Additionally, in the aforementioned warming operation, the discharge current of the smoothing capacitor 38 does not flow through the motor 80, thereby preventing the generation of noise by the motor 80. Additionally, since the three series switch circuits 34 are controlled synchronously, the occurrence of potential differences between the output wirings 33U, 33V, and 33W can be suppressed. That is, in the first operation, since the upper switching elements 35UU, 35VU, and 35WU are turned to the regular on-state, the output wirings 33U, 33V, and 33W are short-circuited via the high potential input wiring 31. Therefore, the output wirings 33U, 33V, and 33W are at the same potential. Additionally, in the second operation, since the lower switching elements 35UL, 35VL, and 35WL are turned to the regular on-state, the output wirings 33U, 33V, and 33W are short-circuited via the low potential input wiring 32. Therefore, the output wirings 33U, 33V, and 33W are at the same potential. In this way, since the occurrence of potential differences between the output wirings 33U, 33V, and 33W can be suppressed, the flow of small currents through the motor 80 can be prevented. Therefore, noise generation in the motor 80 can be prevented more effectively.

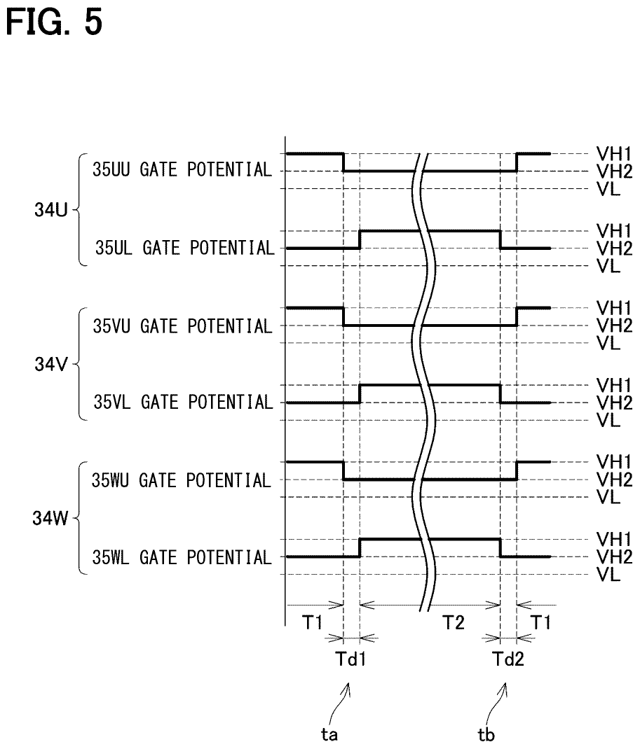

FIG. 5 shows the details of the changes in gate potential at the switching timings ta and tb between the first operation and the second operation shown in FIG. 3. At the switching timing ta from the first operation to the second operation, the controller 90 lowers the gate potential at the upper switching element 35UU from the first gate-on potential VH1 to the second gate-on potential VH2, and then raises the gate potential at the lower switching element 35UL from the second gate-on potential VH2 to the first gate-on potential VH1. In other words, a dead time Td1 is provided between the timing of lowering the gate potential at the upper switching element 35UU and the timing of raising the gate potential at the lower switching element 35UL. In other words, a dead time Td1 is provided between the timing of lowering the gate potential at the upper switching element 35UU and the timing of raising the gate potential at the lower switching element 35UL. In the same way, overcurrent is prevented by the dead time Td1 in the series switch circuits 34V and 34W.

At the switching timing tb from the second operation to the first operation, the controller 90 lowers the gate potential at the lower switching element 35UL from the first gate-on potential VH1 to the second gate-on potential VH2, and then raises the gate potential at the upper switching element 35UU from the second gate-on potential VH2 to the first gate-on potential VH1. In other words, a dead time Td2 is provided between the timing of lowering the gate potential at the lower switching element 35UL and the timing of raising the gate potential at the upper switching element 35UU. In other words, a dead time Td2 is provided between the timing of lowering the gate potential at the upper switching element 35UU and the timing of raising the gate potential at the lower switching element 35UL. In the same way, overcurrent is prevented by the dead time Td2 in the series switch circuits 34V and 34W.

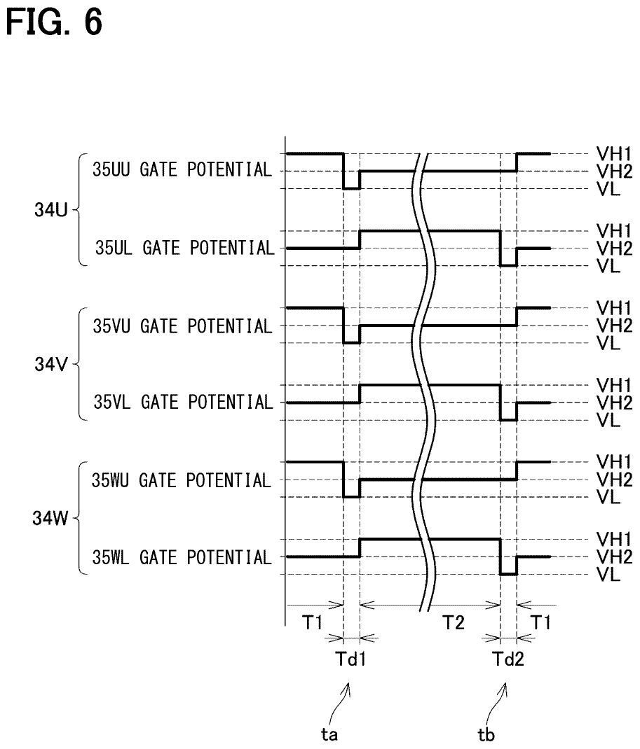

Incidentally, during the dead time, each gate potential may be controlled as shown in FIG. 6. In FIG. 6, at timing ta, the controller 90 lowers the gate potential at the upper switching element 35UU from the first gate-on potential VH1 to the gate-off potential VL. Then, after the dead time Td1 elapses, the controller 90 raises the gate potential at the upper switching element 35UL from the gate-off potential VL to the second gate-on potential VH2 and raises the gate potential at the lower switching element 35UL from the second gate-on potential VH2 to the first gate-on potential VH1. The gate potential at the lower switching element 35UL is raised from the second gate-on potential VL to the first gate-on potential VH1. At timing tb, the controller 90 lowers the gate potential at the lower switching element 35UL from the first gate-on potential VH1 to the gate-off potential VL. Then, after the dead time Td2 elapses, the controller 90 raises the gate potential at the lower switching element 35UL from gate-off potential VL to second gate-on potential VH2 and raises the gate potential at the upper switching element 35UU from second gate-on potential VH2 to first gate-on potential VH1. The gate potential at the upper switching element 35UU is raised from the second gate-on potential VL to the first gate-on potential VH1. This control method also prevents overcurrent from flowing through the series switch circuit 34U. In addition, in the series switch circuits 34V and 34W, overcurrent is also prevented by the dead times Td1 and Td2. In other embodiments, during the dead times Td1 and Td2, both the upper switching element and the lower switching element may be controlled to be in an off-state.

Additionally, as described above, the currents IU, IV, and IW flowing through the output wirings 33U, 33V, and 33W are detected by the current sensors. If a current is detected in any of the output wirings 33U, 33V, or 33W during the execution of the warming operation, the controller 90 will urgently stop the warming operation. During an emergency stop, the controller 90 controls the upper switching elements 35UU, 35VU, and 35WU to be in the regular on-state, while controlling the lower switching elements 35UL, 35VL, and 35WL to be in the off-state. By turning off the lower switching elements 35UL, 35VL, and 35WL, a short circuit between the high-potential input wiring 31 and the low-potential input wiring 32 can be prevented. Additionally, by turning the upper switching elements 35UU, 35VU, and 35WU to the regular on-state, the output wirings 33U, 33V, and 33W can be brought to the same potential, thereby preventing the generation of unintended currents. Additionally, during an emergency stop, it is also possible to control the upper switching elements 35UU, 35VU, and 35WU to be in the off-state, while controlling the lower switching elements 35UL, 35VL, and 35WL to be in the regular on-state.

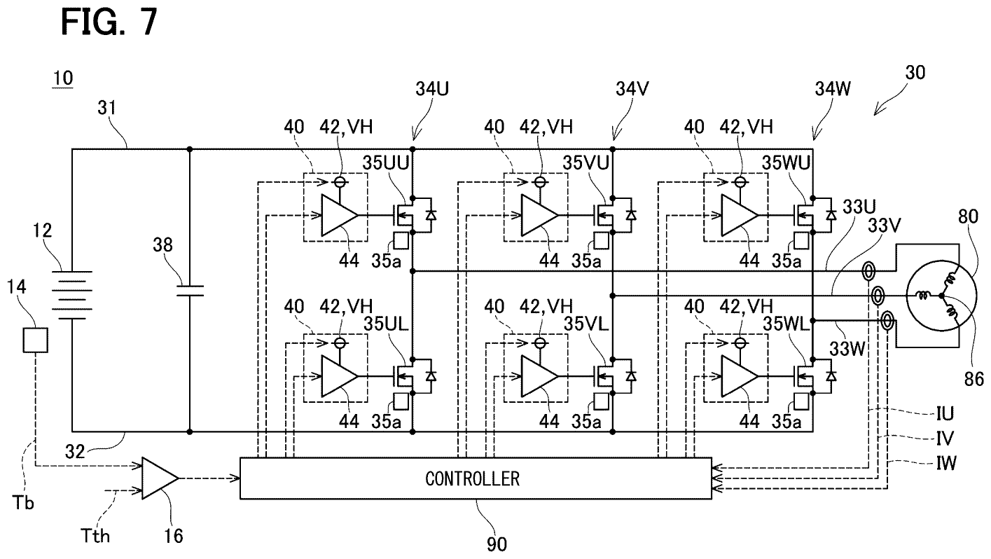

Additionally, as shown in FIG. 7, each switching element 35 may be provided with a temperature sensor 35a. The temperature sensor 35a detects the temperature of the corresponding switching element 35. Although not shown in the drawing, the detected values from each temperature sensor 35a are provided to the controller 90. The controller 90 changes the second gate-on potential VH2 for the switching element 35, which is the target switching element in the high-dissipation on-state, according to the temperature of the switching element 35. The controller 90 lowers the second gate-on potential VH2 for the switching element 35 when its temperature is high, thereby reducing the heat generation of the switching element 35. Thus, an excessive rise in the temperature of the switching element 35 can be prevented.

Instead of the temperature sensor 35a shown in FIG. 7, a current sensor may be provided for each switching element 35. The current sensor detects the source current flowing through the corresponding switching element. The detection values from each current sensor are provided into the controller 90 The controller 90 changes the second gate-on potential VH2 for the switching element 35, which is a target in the high-dissipation on-state, according to the source current of that switching element 35. The controller 90 lowers the second gate-on potential VH2 for the switching element 35 when the source current of that switching element 35 is high, thereby reducing the heat generation of the switching element 35. Thus, excessive temperature rise of the switching element 35 can be prevented. Additionally, the temperature sensor and the current sensor may be provided for each switching element 35, and the second gate-on potential VH2 can be adjusted based on both temperature and current.

### Second Embodiment

An electric circuit in a second embodiment has the same circuit configuration as the electric circuit 10 in the first embodiment shown in FIG. 1. However, in the second embodiment, the gate-on voltage VH output by each power supply circuit 42 is fixed to the first gate-on voltage VH1 (i.e., a value sufficiently higher than the gate threshold). In the second embodiment, unlike in the first embodiment, when controlling each switching element to high-dissipation on-state, the controller 90 inputs a high-frequency pulse signal to the gate of each switching element 35.

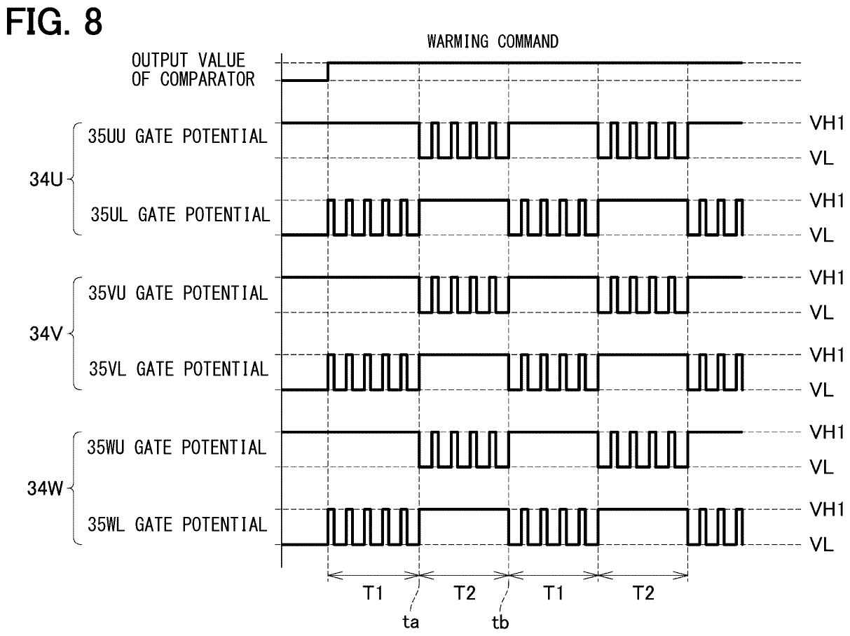

FIG. 8 shows the gate potentials of the six switching elements 35 during the warming operation in the second embodiment. When the warming operation starts, the controller 90 performs the first operation in period T1 and the second operation in period T2. As shown in FIG. 8, the controller 90 repeats the first and second operations alternately.

In the first operation (i.e., period T1), the controller 90 fixes the gate potential at the upper switching element 35UU to the first gate-on potential VH1 (e.g., 20 V). Therefore, in the first operation, the upper switching element 35UU is turned to the regular on-state. In the first operation, the controller 90 changes the gate potential at the lower switching element 35UL to the first gate-on potential VH1 and the gate-off potential VL at high frequency. In other words, the controller 90 controls the gate potential output circuit 44 to provide a high-frequency pulse signal to the gate of the lower switching element 35UL. The high-frequency pulse signal varies between the first gate-on potential VH1 and the gate-off potential VL. By varying the gate potential at the lower switching element 35UL at a high frequency in this manner, the lower switching element 35UL turns on with a higher on-resistance than in the regular on-state. In other words, the lower switching element 35UL is turned to the high-dissipation on-state. As described above, in the first operation, the upper switching element 35UU is in the regular on-state, while the lower switching element 35UL is in the high-dissipation on-state. Therefore, in the first operation, the lower switching element 35UL generates heat.

In the second operation (i.e., period T2), the controller 90 fixes the gate potential at the lower switching element 35UL to the first gate-on potential VH1. Therefore, in the second operation, the lower switching element 35UL is turned to the regular on-state. In the second operation, the controller 90 also varies the gate potential at the upper switching element 35UU between the first gate-on potential VH1 and the gate-off potential VL at a high frequency. That is, by controlling the gate potential output circuit 44, the controller 90 provides a high-frequency pulse signal, which varies between the first gate-on potential VH1 and the gate-off potential VL, to the gate of the upper switching element 35UU. By varying the gate potential at the upper switching element 35UU at a high frequency in this manner, the upper switching element 35UU enters the high-dissipation on-state. As described above, in the second operation, the lower switching element 35UL enters on the regular on-state, while the upper switching element 35UU enters the high-dissipation on-state. Therefore, in the second operation, the upper switching element 35UU generates heat.

Since the controller 90 alternates between the first operation and the second operation, the upper switching element 35UU and the lower switching element 35UL generate heat alternately during the warming operation.

As shown in FIG. 8, during the warming operation, the controller 90 executes the first operation and the second operation in synchronization with the series switch circuit 34U for the series switch circuits 34V and 34W. Therefore, in the first operation (i.e., period T1), the upper switching elements 35UU, 35VU, and 35WU are in the regular on-state, and the lower switching elements 35UL, 35VL, and 35WL are in the high-dissipation on-state. Therefore, in the first operation, the lower switching elements 35UL, 35VL, and 35WL generate heat. Additionally, in the second operation (i.e., period T2), the lower switching elements 35UL, 35VL, and 35WL are in the regular on-state, and the upper switching elements 35UU, 35VU, and 35WU are in a high-dissipation on-state. Therefore, in the second operation, the upper switching elements 35UU, 35VU, and 35WU generate heat. In this way, during the warming operation, the upper switching elements 35UU, 35VU, and 35WU, and the lower switching elements 35UL, 35VL, and 35WL generate heat alternately.

The heat generated by each switching element 35 is transferred to the battery 12 via the coolant circulating within the coolant flow path 52, thereby heating the battery 12. In the second embodiment as well, the warming operation can raise the temperature of the battery 12, thereby restoring the charging and discharging performance of the battery.

Furthermore, in the warming operation in the second embodiment, since each switching element 35 is alternately switched between the regular on-state and the high-dissipation on-state, it prevents the temperature of each switching element 35 from becoming excessively high. Additionally, since the upper switching elements and lower switching elements are alternately heated, the coolant can be heated efficiently. Additionally, since the warming operation is performed using the three series switch circuits 34, the coolant can be heated more efficiently. Thus, the temperature of the battery 12 can be raised efficiently.

Furthermore, in the warming operation in the second embodiment, since the discharge current path of the smoothing capacitor 38 does not pass through the motor 80, it can prevent noise generation by the motor 80. Additionally, since the three series switch circuits 34 are controlled synchronously, the occurrence of potential differences between the output wirings 33U, 33V, and 33W can be suppressed. Therefore, it can prevent small currents from flowing through the motor 80, and more effectively prevent the generation of noise in the motor 80.

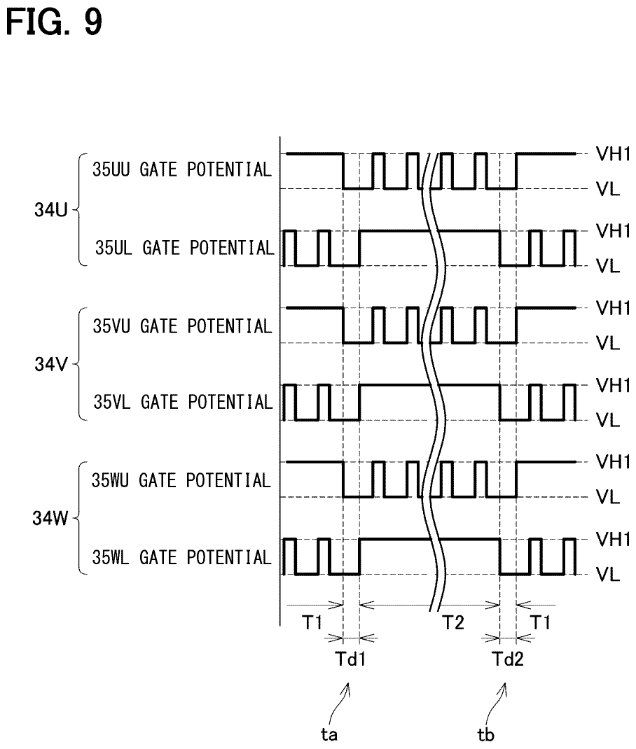

FIG. 9 shows the details of the gate potential changes at the switching timings ta and tb between the first operation and the second operation shown in FIG. 8. At the timing ta when switching from the first operation to the second operation, the controller 90 lowers the gate potential at the upper switching element 35UU from the first gate-on potential VH1 to the gate-off potential VL upon the completion of the high-dissipation on-state of the lower switching element 35UL. Subsequently, after the dead time Td1 has elapsed, the gate potential at the lower switching element 35UL is raised from the gate-off potential VL to the first gate-on potential VH1. Subsequently, the upper switching element 35UU is controlled to be in a high-dissipation on-state. In this manner, a dead time Td1 is provided between the period during which the upper switching element 35UU is in the regular on-state and the period during which the lower switching element 35UL is in the regular on-state, and during the dead time Td1, both the upper switching element 35UU and the lower switching element 35UL are controlled to be in the off-state. In other words, a dead time Td1 is provided between the timing of lowering the gate potential at the upper switching element 35UU and the timing of raising the gate potential at the lower switching element 35UL. Similarly, in the series switch circuits 34V and 34W, overcurrent is prevented by the dead time Td1.

At the timing tb when switching from the second operation to the first operation, the controller 90 lowers the gate potential at the lower switching element 35UL from the first gate-on potential VH1 to the gate-off potential VL at the end of the high-dissipation on-state of the upper switching element 35UU Afterward, after the elapse of the dead time Td2, the gate potential at the upper switching element 35UU is raised from the gate-off potential VL to the first gate-on potential VH1. After that, the lower switching element 35UL is controlled to be in the high-dissipation on-state. In this way, a dead time Td2 is provided between the period when the lower switching element 35UL is in the regular on-state and the period when the upper switching element 35UU is in the regular on-state, and during the dead time Td2, both the upper switching element 35UU and the lower switching element 35UL are controlled to be in the off-state. In other words, a dead time Td1 is provided between the timing of lowering the gate potential at the upper switching element 35UU and the timing of raising the gate potential at the lower switching element 35UL. Similarly, in the series switch circuits 34V and 34W, overcurrent is prevented by the dead time Td2.

In the second embodiment, as in the first embodiment, the warming operation may also be stopped urgently when a current is detected in any of the output wirings 33U, 33V, or 33W during the execution of the warming operation.

Additionally, in the second embodiment as well, as shown in FIG. 7, each switching element 35 may be provided with a temperature sensor 35a. In this case, the controller 90 changes the duty ratio of the pulse signal input to the gate of the switching element 35, which is the target switching element in the high-dissipation on-state, according to the temperature of the switching element 35. In this specification, the duty ratio refers to the ratio of the period during which the first gate-on potential VH1 is output in the pulse signal. The controller 90 lowers the duty ratio of the pulse signal when the temperature of the switching element 35 is high. For example, the duty ratio can be lowered by reducing the ratio of the period during which the first gate-on potential VH1 is output, without changing the frequency of the pulse signal. Also, for example, the duty ratio can be lowered by shortening the period during which the first gate-on potential VH1 is output without changing the duration of the gate-off potential VL output period. Also, for example, the duty ratio can be lowered by lengthening the period during which the gate-off potential VL is output without changing the duration of the period during which the first gate-on potential VH1 is output. In this way, by lowering the duty ratio of the pulse signal, the heat generation of the switching element 35 during high-dissipation on-state can be reduced. As a result, an excessive increase in the temperature of the switching element 35 can be prevented.

In addition, in the second embodiment, a current sensor may be provided for each switching element 35 instead of the temperature sensor 35a. The controller 90 changes the duty ratio of the pulse signal input to the gate of the switching element 35, which is subject to high-dissipation on-state, according to the source current of the switching element 35. When the source current of the switching element 35 is high, the controller 90 lowers the duty ratio of the pulse signal provided to the gate of the switching element 35, thereby reducing the heat generation of the switching element 35. As a result, an excessive increase in the temperature of the switching element 35 can be prevented. Additionally, a temperature sensor and a current sensor may be provided for each switching element 35, and the duty ratio of the pulse signal may be adjusted based on both the temperature and the current.

### Third Embodiment

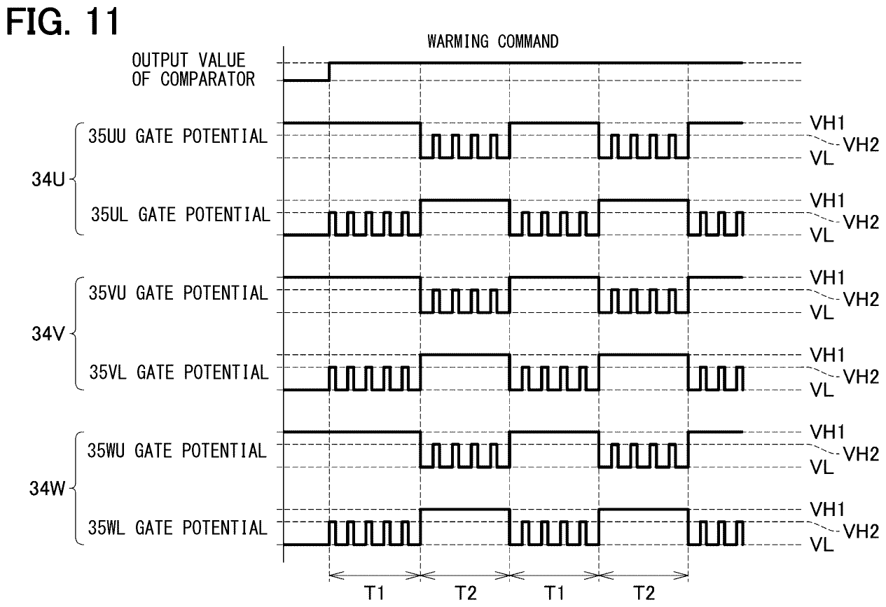

An electric circuit in a third embodiment, similar to the electric circuit in the second embodiment, applies a high-frequency pulse signal that varies between the gate-on potential and the gate-off potential to the gate of each switching element 35 during high-dissipation on-state. However, in the third embodiment, as shown in FIG. 11, the gate-on potential VH2 used during high-dissipation on-state is lower than the gate-on potential VH1 used during the regular on-state. Except for this point, the configuration of the electric circuit in the third embodiment is identical to that of the electric circuit in the second embodiment.

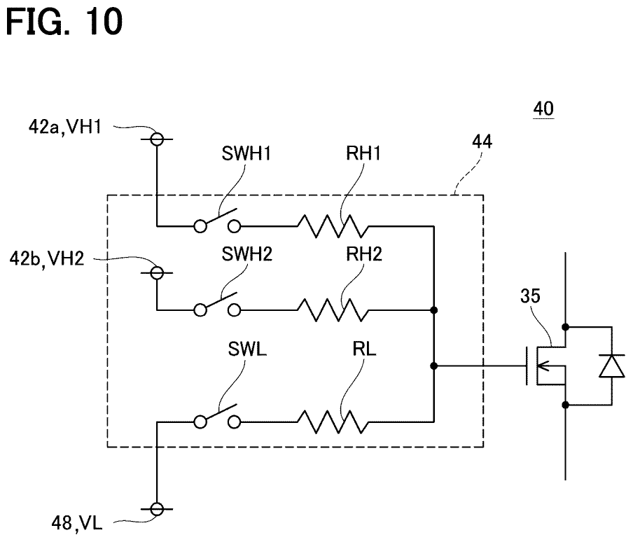

FIG. 10 shows each gate drive circuit 40 in the third embodiment. The gate drive circuit 40 is connected to the gate of the switching element 35 being a controlled target (hereinafter sometimes referred to as the controlled gate or the gate to be controlled). In the gate drive circuit 40 in the third embodiment, the gate potential output circuit 44 is connected to the power supply circuits 42a, 42b, and the gate-off potential output circuit 48. The power supply circuit 42a outputs the gate-on potential VH1. The power supply circuit 42b outputs the gate-on potential VH2. The gate-on potential VH2 is higher than the gate threshold but lower than the gate-on potential VH1. The gate-off potential output circuit 48 outputs the gate-off potential VL (i.e., the source potential at the switching element 35 being a controlled target).

The gate potential output circuit 44 includes a first gate-on switch SWH1, a first gate-on resistor RH1, a second gate-on switch SWH2, a second gate-on resistor RH2, a gate-off switch SWL, and a gate-off resistor RL. The first gate-on switch SWH1, the second gate-on switch SWH2, and the gate-off switch SWL are switching elements and are controlled by the controller 90.

One terminal of the first gate-on switch SWH1 is connected to the power supply circuit 42a. The other terminal of the first gate-on switch SWH1 is connected to the gate to be controlled via the first gate-on resistor RH1. When the first gate-on switch SWH1 is turned on, gate current flows from the power supply circuit 42a through the first gate-on switch SWH1 and the first gate-on resistor RH1 to the gate to be controlled, and the gate to be controlled is charged.

One terminal of the second gate-on switch SWH2 is connected to the power circuit 42b. The other terminal of the second gate-on switch SWH2 is connected to the gate to be controlled via the second gate-on resistor RH2. When the second gate-on switch SWH2 is turned on, gate current flows from the power supply circuit 42b through the second gate-on switch SWH2 and the second gate-on resistor RH2 to the gate to be controlled, and the gate to be controlled is charged.

One terminal of the gate-off switch SWL is connected to the gate-off potential output circuit 48. The other terminal of the gate-off switch SWL is connected to the gate to be controlled via a gate-off resistor RL. When gate-off switch SWL is turned on, gate current flows from the gate to be controlled to the gate-off potential output circuit 48 via the gate-off resistor RL and the gate-off switch SWL, and the gate to be controlled is discharged.

FIG. 11 shows the gate potential at each of the switching elements 35 during the warming operation in the third embodiment. In the warming operation of FIG. 11, similar to the warming operation of FIG. 8, high-frequency pulse signals are input to the gate being controlled during high-dissipation on-state. However, in FIG. 11, the gate-on potential VH2 applied to the gate being controlled during high-dissipation on-state is lower than the gate-on potential VH1 applied to the gate being controlled during regular on-state. Except for this point, the warming operation in FIG. 11 is the same as the warming operation in FIG. 8. The operation of the gate drive circuit 40 in the warming operation is described below.

In the regular on-state, the controller 90 controls the second gate-on switch SWH2 and gate-off switch SWL to the off-state and the first gate-on switch SWH1 to the on-state. Therefore, the gate-on potential VH1 output by the power supply circuit 42a is applied to the gate to be controlled. Therefore, as shown in FIG. 11, in the regular on-state, the gate-on potential VH1 is applied to the gate being a controlled target.

In the high-dissipation on-state, the controller 90 normally controls the first gate-on switch SWH1 to be in the off-state, and alternately turns the second gate-on switch SWH2 and the gate-off switch SWL to the on-state. In the state where the second gate-on switch SWH2 is in the on-state (i.e., the gate-off switch SWL is in off-state), the gate-on potential VH2 output by the power supply circuit 42b is applied to the gate being the controlled target. In the state where the gate-off switch SWL is in the on-state (i.e., the second gate-on switch SWH2 is in the off-state), the gate-off potential VL output by the gate-off potential output circuit 48 is applied to the gate being controlled. Therefore, as shown in FIG. 11, in the high-dissipation on-state, the potential at the gate being the controlled target alternates at a high frequency between the gate-on potential VH2 and the gate-off potential VL.

As explained above, in the high-dissipation on-state of the third embodiment, the gate potential being the controlled target alternates at a high frequency between the gate-on potential VH2 and the gate-off potential VL. That is, the gate-on potential VH2 used in the high-dissipation on-state is lower than the gate-on potential VH1 used in the regular on-state. Therefore, in the third embodiment (i.e., FIG. 11), the on-resistance of switching element 35 at the high-dissipation on-state is higher than in the second embodiment (i.e., FIG. 8). This can suppress the current flowing through the switching element 35 at the high-dissipation on-state.

In addition, In the third embodiment, it is possible to reduce the potential difference between output wirings 33U, 33V, and 33W, as explained below. When the upper switching element 35 is in the high-dissipation on-state and the lower switching element 35 is in the regular on-state, the resistance in the high-dissipation on-state is large, so the potentials of the output wirings 33U, 33V, and 33W become closer to the potential at the low-potential input wiring 32. As a result, it becomes difficult for potential differences to occur between the output wirings 33U, 33V, and 33W. Additionally, when the upper switching element 35 is in the regular on-state and the lower switching element 35 is in a high-dissipation on-state, the potentials of the output wirings 33U, 33V, and 33W become closer to the potential at the high-potential input wiring 31. As a result, it becomes difficult for potential differences to occur between the output wirings 33U, 33V, and 33W. In this way, when synchronizing the three series switch circuits 34U, 34V, and 34W, the resistance in the high-dissipation on-state increases, which can reduce the potential differences between the output wirings 33U, 33V, and 33W. As a result, it is possible to suppress the small current flowing to the motor 80 during warming operation, and effectively reduce the generation of noise in the motor 80.

### Fourth Embodiment

An electrical circuit in a fourth embodiment, similar to the electrical circuit in the third embodiment, applies a high-frequency pulse signal that varies between the gate-on potential VH2 (i.e., a gate-on potential lower than VH1) and the gate-off potential VL to the gate of each switching element during high-dissipation on-state. However, in the fourth embodiment, the configuration of the gate drive circuit 40 is different from the third embodiment. Except for this point, the configuration of the electrical circuit in the fourth embodiment is the same as that of the electrical circuit in the third embodiment.

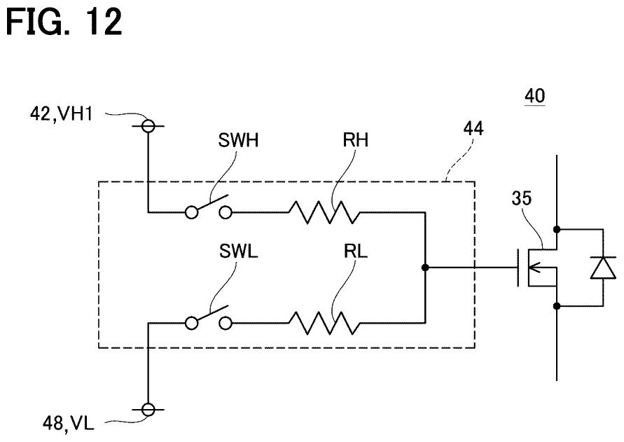

FIG. 12 shows each gate drive circuit 40 in the fourth embodiment. The gate drive circuit 40 is connected to the gate being the controlled target. In the gate drive circuit 40 in the fourth embodiment, the gate potential output circuit 44 is connected to the power supply circuit 42 and the gate-off potential output circuit 48. The power supply circuit 42 outputs the gate-on potential VH1. The gate-off potential output circuit 48 outputs the gate-off potential VL (i.e., the source potential at the switching element 35 being the controlled target).

The gate potential output circuit 44 includes a gate-on switch SWH, a gate-on resistor RH, a gate-off switch SWL, and a gate-off resistor RL. The gate-on switch SWH and the gate-off switch SWL are switching elements and are controlled by the controller 90.

One terminal of the gate-on switch SWH is connected to the power supply circuit 42. The other terminal of gate-on switch SWH is connected to the gate, which is the controlled target, via the gate-on resistor RH. When the gate-on switch SWH is turned on, gate current flows from the power supply circuit 42 to the gate being the controlled target through the gate-on switch SWH and the gate-on resistor RH, thereby charging the gate being the controlled target.

One terminal of the gate-off switch SWL is connected to the gate-off potential output circuit 48. The other terminal of the gate-off switch SWL is connected to the gate to be controlled via a gate-off resistor RL. When gate-off switch SWL is turned on, gate current flows from the gate to be controlled to the gate-off potential output circuit 48 via the gate-off resistor RL and the gate-off switch SWL, and the gate to be controlled is discharged.

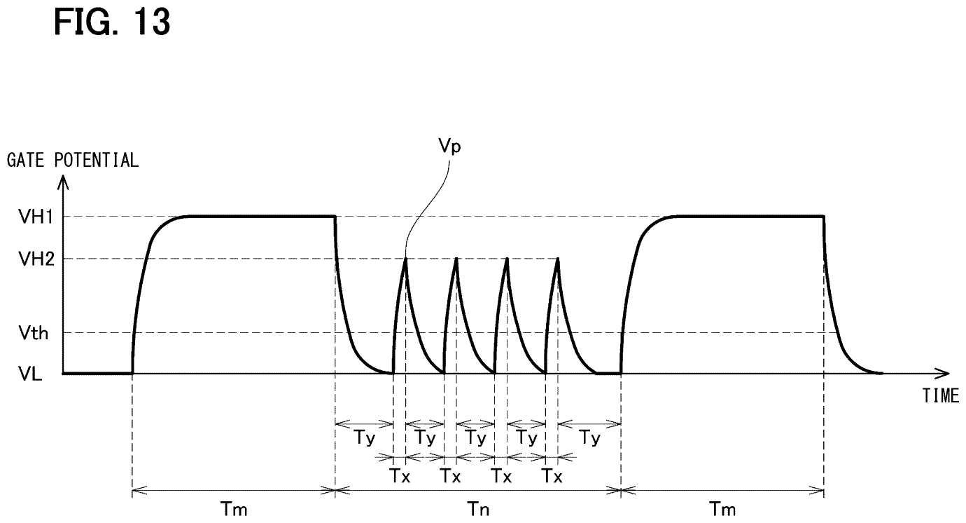

The electrical circuit in the fourth embodiment performs the warming operation in the same manner as in the third embodiment (i.e., as shown in FIG. 11). FIG. 13 shows the gate potentials in warming operation in the fourth embodiment in detail. In FIG. 13, the period Tm is the regular on-state period, and the period Tn is the high-dissipation on-state period. The operation of the gate drive circuit 40 in the warming operation is described below.

During the regular on-state period (i.e., period Tm in FIG. 13), the controller 90 controls the gate-on switch SWH to be in the on-state and the gate-off switch SWL to be in the off-state. Therefore, gate current flows from the power supply circuit 42 to the gate being the controlled target, thereby charging the gate being the controlled target. This causes the gate potential to rise immediately after the start of period Tm. Since the current path through which the gate current flows is an RC circuit having the gate-on resistor RH and the gate capacitance, the gate potential rises with a predetermined slope. Since the regular on-state period Tm is long, the gate potential reaches the gate-on potential VH1 (i.e., the output potential at the power supply circuit 42) within the period Tm. In this manner, during the regular on-state period, the gate-on potential VH1 is applied to the gate being the controlled target.

During the high-dissipation on-state period (i.e., period Tn in FIG. 13), the controller 90 alternates turning the gate-on switch SWH and the gate-off switch SWL to the on-state. In FIG. 13, period Tx is the duration when the gate-on switch SWH is in the on-state (i.e., the period when the gate-off switch SWL is in the off-state), and period Ty is the duration when the gate-off switch SWL is the on-state (i.e., the period when the gate-on switch SWH is in the off-state). During period Ty, gate current flows from the gate being the controlled target to the gate-off potential output circuit 48 through the gate-off resistor RL and the gate-off switch SWL, discharging the gate being the controlled target. During the period Ty, the gate potential drops to the gate-off potential VL. During period Tx, gate current flows from the power supply circuit 42 to the gate being the controlled target through the gate-on switch SWH and the gate-on resistor RH, charging the gate being the controlled target. This causes the gate potential to rise immediately after the start of period Tx. The gate potential rises at a predetermined slope. The period Tx is set to be short, and the period Tx ends before the gate potential reaches the gate-on potential VH1. In period Ty after period Tx, the gate being the controlled target is discharged as described above, and the gate potential drops to the gate-off potential VL. Therefore, at the last timing of period Tx, the gate potential reaches its peak value Vp. The length of period Tx is set so that the peak value Vp is the gate-on potential VH2 (i.e., a potential lower than the gate-on potential VH1 and higher than the gate threshold Vth). Thus, during the high-dissipation on-state period Tn, the gate potential changes at a high frequency between the gate-on potential VH2 and the gate-off potential VL.

As explained above, in the high-dissipation on-state, the gate potential being the controlled target changes at a high frequency between gate-on potential VH2 and gate-off potential VL. Therefore, in the fourth embodiment, as in the third embodiment, the on-resistance of the switching element 35 in the high-dissipation on-state can be higher. Therefore, it is possible to suppress the current flowing through the switching element 35 in the high-dissipation on-state. Additionally, the generation of potential differences between the output wirings 33U, 33V, and 33W is suppressed, thereby preventing small currents from flowing into the motor 80. Additionally, according to the configuration in the fourth embodiment, the potential VH2 can be generated based on the potential VH1, eliminating the need for a dedicated power supply circuit to generate the potential VH2. Thus, the electric circuit can be downsized.

### Fifth Embodiment

An electric circuit in a fifth embodiment, similar to the electric circuit in the second embodiment, applies a high-frequency pulse signal that varies between the gate-on potential VH1 and the gate-off potential VL to the gate of each switching element 35 during the high-dissipation on-state. However, the electric circuit in the fifth embodiment can change the discharging speed when discharging the gate of each switching element 35. Except for this point, the electric circuit in the fifth embodiment is identical to the electric circuit in the second embodiment. The discharging speed may also be referred to as a discharging rate.

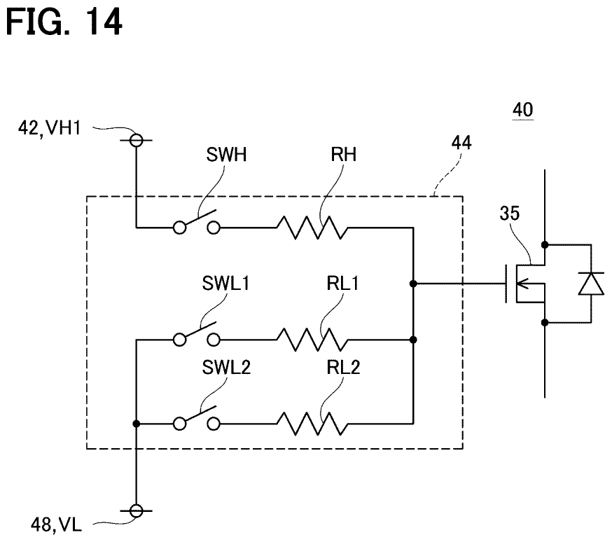

FIG. 14 illustrates each gate drive circuit 40 in the fifth embodiment. The gate drive circuit 40 is connected to the gate being the controlled target. In the gate drive circuit 40 in the fifth embodiment, the gate potential output circuit 44 is connected to the power supply circuit 42 and the gate-off potential output circuit 48. The power supply circuit 42 outputs the gate-on potential VH. The gate-off potential output circuit 48 outputs the gate-off potential VL (i.e., the source potential at the switching element 35 being the controlled target).

The gate potential output circuit 44 includes a gate-on switch SWH, a gate-on resistor RH, a first gate-off switch SWL1, a first gate-off resistor RL1, a second gate-off switch SWL2, and a second gate-off resistor RL2. The gate-on switch SWH, the first gate-off switch SWL1, and the second gate-off switch SWL2 are switching elements and are controlled by the controller 90.

One terminal of the gate-on switch SWH is connected to the power supply circuit 42. The other terminal of gate-on switch SWH is connected to the gate, which is the controlled target, via the gate-on resistor RH. When the gate-on switch SWH is turned on, gate current flows from the power supply circuit 42 to the gate being the controlled target through the gate-on switch SWH and the gate-on resistor RH, thereby charging the gate being the controlled target.

One terminal of the first gate-off switch SWL1 is connected to the gate-off potential output circuit 48. The other terminal of the first gate-off switch SWL1 is connected to the gate being the controlled target via the first gate-off resistor RL1. When the first gate-off switch SWL1 is turned on, gate current flows from the gate being the controlled target to the gate-off potential output circuit 48 through the first gate-off resistor RL1 and the first gate-off switch SWL1, discharging the gate being the controlled target.

One terminal of the second gate-off switch SWL2 is connected to the gate-off potential output circuit 48. The other terminal of the second gate-off switch SWL2 is connected to the gate being the controlled target via the second gate-off resistor RL2. The electrical resistance of the second gate-off resistor RL2 is higher than that of the first gate-off resistor RL1. When the second gate-off switch SWL2 is turned on, gate current flows from the gate being controlled target to the gate-off potential output circuit 48 through the second gate-off resistor RL2 and the second gate-off switch SWL2, discharging the gate being the controlled target. Since the electrical resistance of the second gate-off resistor RL2 is higher than that of the first gate-off resistor RL1, when the second gate-off switch SWL2 is turned on, the discharge rate of the gate (i.e., the rate at which the gate potential decreases) is slower compared to when the first gate-off switch SWL1 is turned on.

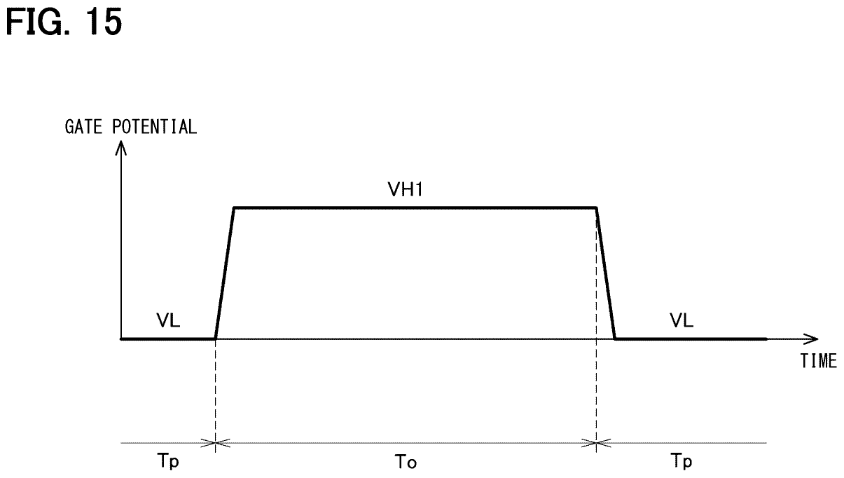

First, the operation of rotating the motor 80 in the fifth embodiment (i.e., the operation of supplying three-phase AC power to the motor 80 via the inverter 30) will be explained. FIG. 15 shows the gate potential at each switching element 35 during the operation of rotating the motor 80. During the operation of rotating the motor 80, the controller 90 constantly controls the second gate-off switch SWL2 to be in the off-state and alternately turns the gate-on switch SWH and the first gate-off switch SWL1 on. During the period To when the gate-on switch SWH is in the on-state (i.e., the period To when the first gate-off switch SWL1 is in the off-state), the gate-on potential VH1 is applied to the gate being the controlled target. During the period Tp when the first gate-off switch SWL1 is in the on-state (i.e., the period Tp when the gate-on switch SWH is in the off-state), the gate-off potential VL is applied to the gate being the controlled target. Therefore, as shown in FIG. 15, during the operation of rotating the motor 80, the potential at the gate being the controlled target alternates between the gate-on potential VH1 and the gate-off potential VL.

Additionally, when switching from period To to period Tp, gate current flows from the gate being the controlled target to the gate-off potential output circuit 48 through the first gate-off resistor RL1 and the first gate-off switch SWL1, discharging the gate being the controlled target. Since the electrical resistance of the first gate-off resistor RL1 is low, the gate discharges rapidly, causing the gate potential to decrease from the gate-on potential VH1 to the gate-off potential VL at a fast rate. Therefore, the drain-source current flowing through the switching element 35 decreases rapidly, resulting in a surge voltage occurring across the drain-source terminals of the switching element. However, during the operation of rotating the motor 80, the motor 80 (i.e., the load) is present in the current path of the drain-source current, so a surge voltage with a significant magnitude does not occur.

Next, the warming operation in the fifth embodiment will be explained. In the fifth embodiment, as in the second embodiment (i.e., FIG. 8), the warming operation is performed. That is, each switching element 35 is controlled to alternate between the regular on-state and the high-dissipation on-state. In the regular on-state, the controller 90 controls the gate-on switch SWH to be in the on-state and the gate-off switches SWL1 and SWL2 to be in the off-state. Therefore, the gate-on potential VH1 output by the power supply circuit 42 is applied to the gate being the controlled target.

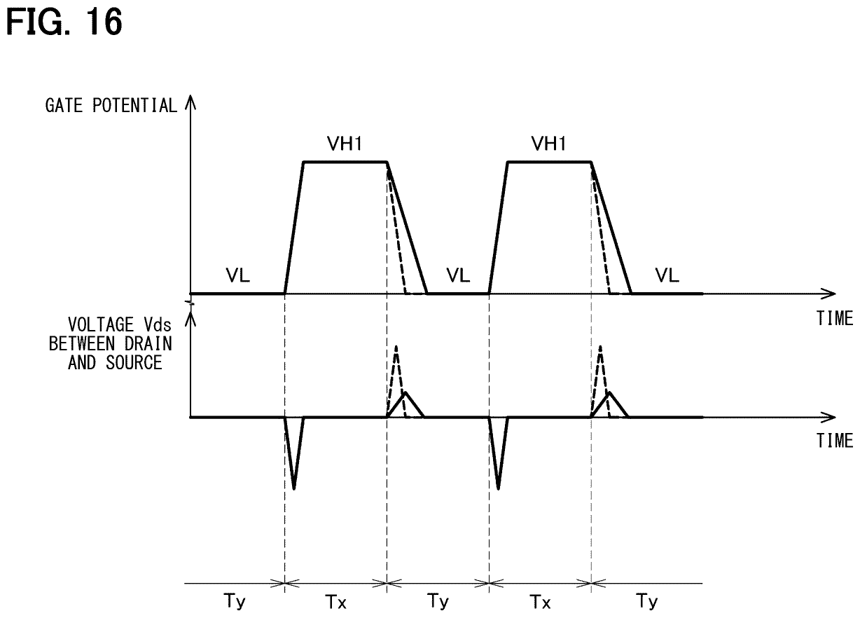

FIG. 16 illustrates the gate potential during the high-loss-on-state in the fifth embodiment. In FIG. 16, the solid line graph indicates the values for the fifth embodiment, while the dashed line graph indicates the values for the comparative example. During the high-dissipation on-state, the controller 90 continuously turns the first gate-off switch SWL1 off and alternately turns the gate-on switch SWH and the second gate-off switch SWL2 on at a high frequency. During the period Tx when the gate-on switch SWH is in the on-state (i.e., the period Tx when the second gate-off switch SWL2 is in the off-state), the gate-on potential VH1 is applied to the gate being the controlled target. During the period Ty when the second gate-off switch SWL2 is in the on-state (i.e., the period Ty when the gate-on switch SWH is in the off-state), the gate-off potential VL is applied to the gate being the controlled target. Therefore, as shown in FIG. 16, during the high-loss-on-state, the potential at the gate being the controlled target alternates at a high frequency between the gate-on potential VH1 and the gate-off potential VL.

Additionally, when switching from period Tx to period Ty, gate current flows from the gate being the controlled target to the gate-off potential output circuit 48 via the second gate-off resistor RL2 and the second gate-off switch SWL2, thereby discharging the gate being the controlled target. Therefore, the drain-source current flowing through the switching element 35 decreases, and a surge voltage is generated across the drain-source of the switching element. During the period Tx, since current flows through the series circuit of the upper switching element 35 and the lower switching element 35, there is no motor 80 (i.e., load) in this current path, and the drain-source current flowing through the switching element 35 during the period Tx is high. Therefore, when switching from period Tx to period Ty, if the gate potential is rapidly decreased as shown by the dashed graph in FIG. 16, the drain-source current decreases abruptly, resulting in an extremely high surge voltage being generated. In contrast, in the fifth embodiment, when switching from period Tx to period Ty, the gate is discharged through the second gate-off resistor RL2, which has a high electrical resistance. As a result, the rate of decrease in the gate potential is slower, which suppresses the generation of high surge voltage.

It is noted that a configuration in which the rate of decrease of the gate potential can be adjusted, as in the fifth embodiment, may also be applied to the third and fourth embodiments. That is, in the gate drive circuit according to the third and fourth embodiments, two types of gate-off resistors for discharging the gate can be provided, and during the high-dissipation on-state, the gate can be discharged more slowly compared to the operation for rotating the motor.

In the above embodiment, the comparator 16 determines whether the temperature Tb is lower than the threshold Tth. However, the detected value of the temperature Tb may be directly provided to the controller 90, and the controller 90 may determine whether the temperature Tb is lower than the threshold Tth. In this case, the temperature Tb data provided to the controller 90 (i.e., data indicating a low temperature) corresponds to a warming command.

Also, in the above embodiment, the heat generated by each switching element 35 was transferred to the battery 12 through the coolant flowing path 52 However, as long as the heat generated by each switching element 35 is transferred to the battery 12, the heat may be transferred through any path.

The present disclosure includes the following configurations.

### Configuration 1

An electric circuit is adapted to a vehicle. The electric circuit includes: a battery; a motor; an inverter connected between the battery and the motor; and a controller. The inverter includes: a high-potential input wiring; a low-potential input wiring; output wirings connected to the motor; a smoothing capacitor connected between the high-potential input wiring and the low-potential input wiring; and series switch circuits connected between the high-potential input wiring and the low-potential input wiring. Each of the series switch circuits includes: an upper switching element connected between the high-potential input wiring and a corresponding one of the output wirings; and a lower switching element connected between the low-potential input wiring and the corresponding one of the output wirings. The controller is configured to execute a warming operation in at least one of the series switch circuits in a case where the controller receives a warming command during a stop of the vehicle. The warming operation is an operation in which the controller switches one of the upper switching element and the lower switching element to a regular on-state, and switches another one of the upper switching element and the lower switching element to a high-dissipation on-state. The high-dissipation on-state results in more energy dissipation than the regular on-state.

### Configuration 2

In the electric circuit according to the Configuration 1, the controller is configured to execute a first operation and a second operation alternately in the at least one of the series switch circuits that is under the warming operation. The first operation is an operation in which the controller sets the upper switching element to the regular on-state, and sets the lower switching element to the high-dissipation on-state. The second operation is an operation in which the controller sets the upper switching element to the high-dissipation on-state, and sets the lower switching element to the regular on-state.

### Configuration 3

In the electric circuit according to the Configuration 2, the controller executes the warming operation in each of the series switch circuits to ensure synchronized execution of the first operation and synchronized execution of the second operation in the series switch circuits, in a case where the controller receives the warming command during the stop of the vehicle.

### Configuration 4

In the electric circuit according to any one of the Configurations 1 to 3, the regular on-state is a state in which a first gate-on potential, which is higher than a gate threshold, is applied to a gate, and the high-dissipation on-state is a state in which a second gate-on potential, which is higher than the gate threshold and lower than the first gate-on potential, is applied to the gate.

### Configuration 5

In the electric circuit according to the Configuration 4, one of the upper switching element and the lower switching element in the at least one of the series switch circuits is a first switching element, and another one of the upper switching element and the lower switching element in the at least one of the series switch circuits is a second switching element. A deadtime is provided between a first period and a second period in a switching period during which the first switching element is switched from the regular on-state to the high-dissipation on-state and the second switching element is switched from the high-dissipation on-state to the regular on-state. The first period is a period during which the first switching element is in the regular on-state, and the second period is a period during which the second switching element is in the regular on-state. The deadtime is a time at which the first switching element is set to either the high-dissipation on-state or an off-state, and the second switching element is set to either the high-dissipation on-state or the off-state.

### Configuration 6

In the electric circuit according to the Configuration 4 or 5, the controller modifies the second gate-on potential that is applied to a gate of a target switching element in the high-dissipation on-state, according to at least one of a temperature or a current of the target switching element in the high-dissipation on-state.

### Configuration 7

In the electric circuit according to any one of the Configurations 1 to 3, the regular on-state is a state in which a gate-on potential, which is higher than a gate threshold, is applied to a gate. The high-dissipation on-state is a state in which a varying voltage is applied to the gate. The varying voltage is varied between the gate-on potential and a gate-off potential that is lower than the gate threshold.

### Configuration 8

In the electric circuit according to the Configuration 7, the gate-on potential includes a first gate-on potential and a second gate-on potential that is lower than the first gate-on potential. The regular on-state is a state in which the first gate-on potential is applied to the gate of the target switching element, and the high-dissipation on-state is a state in which the second gate-on potential is applied to the gate of the target switching element.

### Configuration 9

The electric circuit according to the Configuration 8 further includes gate drive circuits. In the electric circuit, each of the gate drive circuits is connected to a gate of a corresponding one of the upper switching element and the lower switching element. The gate of the corresponding one of the upper switching element and the lower switching element is a corresponding gate. Each of the gate drive circuits includes: a power supply circuit that outputs the first gate-on potential; a gate-off potential output circuit that outputs the gate-off potential; and a switchover circuit that executes switchover between a first state and a second state. The first state is a state in which the power supply circuit is connected to the corresponding gate, and the second state is a state in which the gate-off potential output circuit is connected to the corresponding gate. The switchover circuit is in the first state in a case where the gate-on potential is applied to the corresponding gate. The switchover circuit is in the second state in a case where the gate-off potential is applied to the corresponding gate. The regular on-state is a state in which a duration of the first state is set to raise a potential at the corresponding gate to the first gate-on potential within the duration of the first state, and the high-dissipation on-state is a state in which the duration of the first state is set to cause the potential at the corresponding gate to be the second gate-on potential at an end of the duration of the first state.

### Configuration 10

The electric circuit according to the Configuration 8 further includes gate drive circuits. In the electric circuit, each of the gate drive circuits is connected to a gate of a corresponding one of the upper switching element and the lower switching element. The gate of the corresponding one of the upper switching element and the lower switching element is a corresponding gate. Each of the gate drive circuits includes: a first power supply circuit that outputs the first gate-on potential; a second power supply circuit that outputs the second gate-on potential; a gate-off potential output circuit that outputs the gate-off potential; and a switchover circuit that executes switchover among a first state, a second state, and a third state. The first state is a state in which the first power supply circuit is connected to the corresponding gate, the second state is a state in which the second power supply circuit is connected to the corresponding gate, and the third state is a state in which the gate-off potential output circuit is connected to the corresponding gate. The switchover circuit is in the third state, in a case where the gate-off potential is applied to the corresponding gate. The switchover circuit is in the first state, in a case where the first gate-on potential is applied to the corresponding gate. The swichover circuit is in the second state, in a case where the second gate-on potential is applied to the corresponding gate. The regular on-state is a state in which the switchover circuit is in the first state, in a case where the first gate-on potential is applied to the corresponding gate. The high-dissipation on-state is a state in which the switchover circuit is in the second state, in a case where the second gate-on potential is applied to the corresponding gate in the high-dissipation on-state.

### Configuration 11

In the electric circuit according to any one of the Configurations 7 to 10, one of the upper switching element and the lower switching element is a first switching element, and another one of the upper switching element and the lower switching element is a second switching element. In the electric circuit, a deadtime is provided between a first period and a second period in a switching period during which the first switching element is switched from the regular on-state to the high-dissipation on-state and the second switching element is switched from the high-dissipation on-state to the regular on-state in the at least one of the series switch circuits. The first period is a period during which the first switching element is in the regular on-state. The second period is a period during which the second switching element is in the regular on-state. The deadtime is a time at which the first switching element and the second switching element are set to an off-state.

### Configuration 12

In the electric circuit according to any one of the Configurations 7 to 11, the

controller modifies a duty ratio of the varying voltage that is applied to the gate of the target switching element in the high-dissipation on-state, according to at least one of a temperature or a current of the target switching element in the high-dissipation on-state.

### Configuration 13

The electric circuit according to any one of the Configurations 7 to 12 includes gate drive circuits. In the electric circuit, each of the gate drive circuits is configured to control a potential at a gate of a corresponding one of the upper switching element and the lower switching element. The corresponding one of the upper switching element and the lower switching element is a corresponding switching element. Each of the gate drive circuits is configured to control the potential at the gate of the corresponding switching element, such that a decreasing rate of the potential at the gate of the corresponding switching element during the warming operation is slower than a decreasing rate of the potential at the gate of the corresponding switching element during an operation of rotating the motor.

### Configuration 14

In the electric circuit according to any one of the Configurations 1 to 13, in a case where a current is detected in at least one of the output wirings during execution of the warming operation, either the upper switching element is set to the regular on-state and the lower switching element is set to an off-state in each of the series switch circuits; or the upper switching element is set to the off-state and the lower switching element is set to the regular on-state in each of the series switch circuits.

### Configuration 15

The electric circuit according to any one of the Configurations 1 to 14 includes a coolant flowing path that cools down the battery and the inverter.

According to the Configuration 2, it is possible to prevent an excessive rise in the temperature of each switching element and increase the amount of heat dissipation of the inverter.

According to the Configuration 3, it is possible to increase the amount of heat dissipation of the inverter.

As in the Configuration 4, it is possible to turn on the switching element in a state that results in high dissipation by applying the second gate-on potential to the gate of the switching element.

According to the Configuration 5, it is possible to suppress the flow of an overcurrent in the series switch circuit.

According to the Configuration 6, it is possible to properly control the temperature of the switching element in the high-dissipation on-state.

As in the Configuration 7, it is possible to turn on the switching element in a state that results in high dissipation, by applying a varying voltage to the gate of the switching element.

According to the Configuration 8, it is possible to increase the on-resistance of the switching element in the high-dissipation on-state.

According to the Configuration 9, it is possible to generate the first gate-on potential and the second gate-on potential in a single power supply circuit.

According to the Configuration 10, it is possible to stabilize the first gate-on potential and the second gate-on potential.

According to the Configuration 11, it is possible to suppress the flow of an overcurrent in the series switch circuit.

According to the Configuration 12, it is possible to properly control the temperature of the switching element turned into the high-dissipation on-state.

According to the Configuration 13, it is possible to reduce a surge voltage occurred at a time of switching from the high-dissipation on-state to the off-state.

According to the Configuration 14, it is possible to stop the warming operation suitably at the time of generation of an abnormal current.

According to the Configuration 15, it is possible to suitably raise the temperature of the battery by the heat generated by the inverter.

Although the embodiments have been described in detail above, these are merely examples and do not limit the scope of the present disclosure. The techniques described in the present disclosure include various modifications and modifications of the specific examples illustrated above. The technical elements described in the present disclosure or the drawings exhibit technical usefulness alone or in various combinations, and are not limited to the combinations described in the present disclosure at the time of filing. In addition, the techniques illustrated in the present specification or drawings achieve multiple objectives at the same time, and achieving one of the objectives itself has technical usefulness.

What is claimed is:

1. An electric circuit configured to be adapted to a vehicle, the electric circuit comprising:
a battery;
a motor;
an inverter connected between the battery and the motor; and
a controller, wherein
the inverter includes:
a high-potential input wiring;
a low-potential input wiring;
output wirings connected to the motor;
a smoothing capacitor connected between the high-potential input wiring and the low-potential input wiring; and
series switch circuits connected between the high-potential input wiring and the low-potential input wiring,
each of the series switch circuits includes:
an upper switching element connected between the high-potential input wiring and a corresponding one of the output wirings; and
a lower switching element connected between the low-potential input wiring and the corresponding one of the output wirings,
the controller is configured to execute a warming operation in at least one of the series switch circuits in a case where the controller receives a warming command during a stop of the vehicle,
the warming operation is an operation in which the controller
sets one of the upper switching element and the lower switching element to a regular on-state, and
sets another of the upper switching element and the lower switching element to a high-dissipation on-state, and
the high-dissipation on-state has higher energy dissipation than the regular on-state.

2. The electric circuit according to claim 1, wherein
the controller is configured to execute a first operation and a second operation alternately in the at least one of the series switch circuits that is under the warming operation,
the first operation is an operation in which the controller sets the upper switching element to the regular on-state, and sets the lower switching element to the high-dissipation on-state, and
the second operation is an operation in which the controller sets the upper switching element to the high-dissipation on-state, and sets the lower switching element to the regular on-state.

3. The electric circuit according to claim 2, wherein
the controller is configured to perform synchronized execution of the first operation and synchronized execution of the second operation in each of the series switch circuits in the warming operation in each of the series switch circuits, in a case where the controller receives the warming command during the stop of the vehicle.

4. The electric circuit according to claim 1, wherein
the regular on-state is a state in which a first gate-on potential, which is higher than a gate threshold, is applied to a gate, and
the high-dissipation on-state is a state in which a second gate-on potential, which is higher than the gate threshold and lower than the first gate-on potential, is applied to the gate.

5. The electric circuit according to claim 4, wherein
one of the upper switching element and the lower switching element in the at least one of the series switch circuits is a first switching element,
another of the upper switching element and the lower switching element in the at least one of the series switch circuits is a second switching element,
a switching period is a period during which the first switching element is switched from the regular on-state to the high-dissipation on-state and the second switching element is switched from the high-dissipation on-state to the regular on-state,
the switching period includes:
a first period that is a period during which the first switching element is in the regular on-state; and
a second period that is a period during which the second switching element is in the regular on-state, and
a deadtime is provided between the first period and the second period, and
the deadtime is a time at which
the first switching element is set to either the high-dissipation on-state or an off-state, and
the second switching element is set to either the high-dissipation on-state or the off-state.

6. The electric circuit according to claim 4, wherein
the controller is configured to modify the second gate-on potential that is applied to a gate of a target switching element that is in the high-dissipation on-state, according to at least one of a temperature or a current of the target switching element that is in the high-dissipation on-state.

7. The electric circuit according to claim 1, wherein
the regular on-state is a state in which a gate-on potential, which is higher than a gate threshold, is applied to a gate, and
the high-dissipation on-state is a state in which a varying voltage is applied to the gate, and
the varying voltage is varied between the gate-on potential and a gate-off potential that is lower than the gate threshold.

8. The electric circuit according to claim 7, wherein
the gate-on potential includes a first gate-on potential and a second gate-on potential that is lower than the first gate-on potential,
the regular on-state is a state in which the first gate-on potential is applied to the gate, and
the high-dissipation on-state is a state in which the second gate-on potential is applied to the gate.

9. The electric circuit according to claim 8, further comprising:
gate drive circuits, wherein
each of the gate drive circuits is connected to a gate of a corresponding one of the upper switching element and the lower switching element,
the gate of the corresponding one of the upper switching element and the lower switching element is a corresponding gate,
each of the gate drive circuits includes:
a power supply circuit configured to output the first gate-on potential;
a gate-off potential output circuit configured to output the gate-off potential; and
a switchover circuit configured to execute switchover between a first state and a second state, the first state being a state in which the power supply circuit is connected to the corresponding gate, the second state being a state in which the gate-off potential output circuit is connected to the corresponding gate,
the switchover circuit is in the first state in a case where the first gate-on potential is applied to the corresponding gate,
the switchover circuit is in the second state in a case where the gate-off potential is applied to the corresponding gate,
the regular on-state is a state in which a duration of the first state is set to raise a potential at the corresponding gate to the first gate-on potential within the duration of the first state, and
the high-dissipation on-state is a state in which the duration of the first state is set to cause the potential at the corresponding gate to be the second gate-on potential at an end of the duration of the first state.

10. The electric circuit according to claim 8, further comprising:
gate drive circuits, wherein
each of the gate drive circuits is connected to a gate of a corresponding one of the upper switching element and the lower switching element
the gate of the corresponding one of the upper switching element and the lower switching element is a corresponding gate,
each of the gate drive circuits includes:
a first power supply circuit configured to output the first gate-on potential;
a second power supply circuit configured to output the second gate-on potential;
a gate-off potential output circuit configured to output the gate-off potential; and
a switchover circuit configured to execute switchover among a first state, a second state, and a third state, the first state being a state in which the first power supply circuit is connected to the corresponding gate, the second state being a state in which the second power supply circuit is connected to the corresponding gate, and the third state being a state in which the gate-off potential output circuit is connected to the corresponding gate, wherein
the switchover circuit is in the third state in a case where the gate-off potential is applied to the corresponding gate,
the switchover circuit is in the first state in a case where the first gate-on potential is applied to the corresponding gate in the regular on-state, and
the switchover circuit is in the second state in a case where the second gate-on potential is applied to the corresponding gate in the high-dissipation on-state.

11. The electric circuit according to claim 7, wherein
one of the upper switching element and the lower switching element is a first switching element,
another of the upper switching element and the lower switching element is a second switching element,
a switching period is a period during which the first switching element is switched from the regular on-state to the high-dissipation on-state and the second switching element is switched from the high-dissipation on-state to the regular on-state in the at least one of the series switch circuits,
the switching period includes:
the first period that is a period during which the first switching element is in the regular on-state; and
the second period that is a period during which the second switching element is in the regular on-state,
a deadtime is provided between a first period and a second period, and
the deadtime is a time at which the first switching element and the second switching element are set to an off-state.

12. The electric circuit according to claim 7, wherein
the controller is configured to modify a duty ratio of the varying voltage that is applied to a gate of a target switching element that is in the high-dissipation on-state, according to at least one of a temperature or a current of the target switching element that is in the high-dissipation on-state.

13. The electric circuit according to claim 7, further comprising:
gate drive circuits, wherein
each of the gate drive circuits is configured to control a potential at a gate of a corresponding one of the upper switching element and the lower switching element,
the gate of the corresponding one of the upper switching element and the lower switching element is a corresponding gate,
each of the gate drive circuits is configured to control the potential at the corresponding gate, such that a decreasing rate of the potential at the corresponding gate during the warming operation is slower than a decreasing rate of the potential at the corresponding gate during an operation of rotating the motor.

14. The electric circuit according to claim 1, wherein
in a case where a current is detected in at least one of the output wirings during execution of the warming operation, either
the upper switching element is set to the regular on-state and the lower switching element is set to an off-state in each of the series switch circuits; or
the upper switching element is set to the off-state and the lower switching element is set to the regular on-state in each of the series switch circuits.

15. The electric circuit according to claim 1, further comprising:
a coolant flowing path configured to cool down the battery and the inverter.
